(19) United States
(12) Patent Application Publication
(10) Pub. No.: US 2008/0107943 A1
(43) Pub. Date: May 8, 2008

(54) CONDENSER IN A FUEL CELL DEVICE

(76) Inventor: WEI-JUI CHUANG, Kaohsiung (TW)

Correspondence Address: G. LINK CO., LTD., 3550 BELL ROAD, MINOOKA, IL, 60447, US

(21) Appl. No.: 11/556,548

(22) Filed: Nov. 3, 2006

(51) Int. Cl. H01M 8/02

(52) U.S. Cl. 429/26

(57) ABSTRACT

A condenser in a fuel cell device includes a casing and a plurality of heat dissipating elements. The casing formed with an enclosed structure and provides casing walls with a steam intake port, a steam outlet port and a plurality of drain ports and a containing space is defined by the casing walls. The heat dissipating elements are disposed in the containing space above the drain ports and arranged to constitute a spiral passage. The spiral passage has an initial end is disposed at the intake port and a terminal end at the outlet port. The drain ports are positioned under the heat dissipating elements. Hence, steam generated during the fuel cell device processing electrochemical reaction can be discharged effectively.

### BACKGROUND OF THE INVENTION

1. Field of the Invention

The present invention is related to a condenser in a fuel cell device and particularly to a condenser which is capable of solving problems created by steam generated during the fuel cell device processing electrochemical reaction.

2. Brief Description of the Related Art

It is known that a fuel cell device is an apparatus to convert chemical energy in a fuel and oxide agent to electrical energy directly by means of electrical pole reaction. Currently, there are a lot of different types of fuel cells and they can be classified as basic fuel cell, phosphoric acid fuel cell, proton exchange film fuel cell, molten carbonic acid fuel cell and solid state oxide fuel cell.

Although fuel cell technology has some progresses in the recent years, a commercialized fuel cell still faces tremendous technical challenges such as low gross efficiency and power density, water control, heat control, miniaturization and cost.

Most of fuel cells produce water after electromechanical reaction is performed and how to treat water production is a subject has to be overcome in fuel cell system design.

### SUMMARY OF THE INVENTION

Accordingly, an object of the present invention is to provide a condenser in a fuel cell device with which steam production is capable of being condensed as water.

Another object of the present invention is to provide a condenser in a fuel cell device with which the steam production can be captured and confined in a closed space without escaping outward.

In order to achieve the preceding objects, a condenser in a fuel cell device according to the present invention includes a casing and a plurality of heat dissipating elements. The casing formed with an enclosed structure and provides casing walls with a steam intake port, a steam outlet port and a plurality of drain ports and a containing space is defined by the casing walls. The heat dissipating elements are disposed in the containing space above the drain ports and arranged to constitute a spiral passage. The spiral passage has an initial end is disposed at the intake port and a terminal end at the outlet port. The drain ports are positioned under the heat dissipating elements. Hence, steam generated during the fuel cell device processing electrochemical reaction can be discharged effectively.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a fragmentarily perspective sectional view of a condenser in a fuel cell device according to the present invention;

FIG. 2A is an exploded perspective view of a casing of a condenser in a fuel cell device according to the present invention;

FIG. 2B is a perspective view illustrating heat dissipating elements in a condenser of a fuel cell device according to the present invention; and

FIG. 3 is a sectional view of a condenser in a fuel cell device according to the present invention.

### DETAILED DESCRIPTION OF THE INVENTION

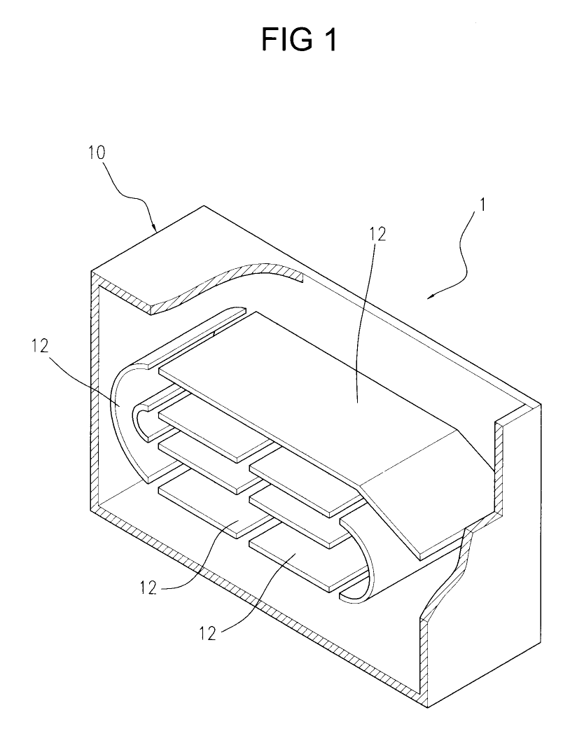

Referring to FIG. 1, a condenser in a fuel cell device according to the present invention includes a casing 10 and a plurality of heat dissipating member 12.

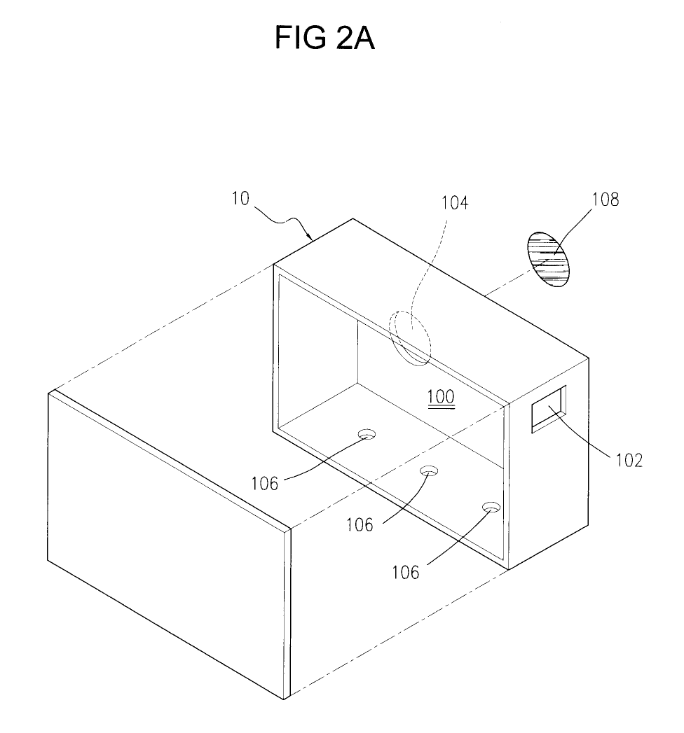

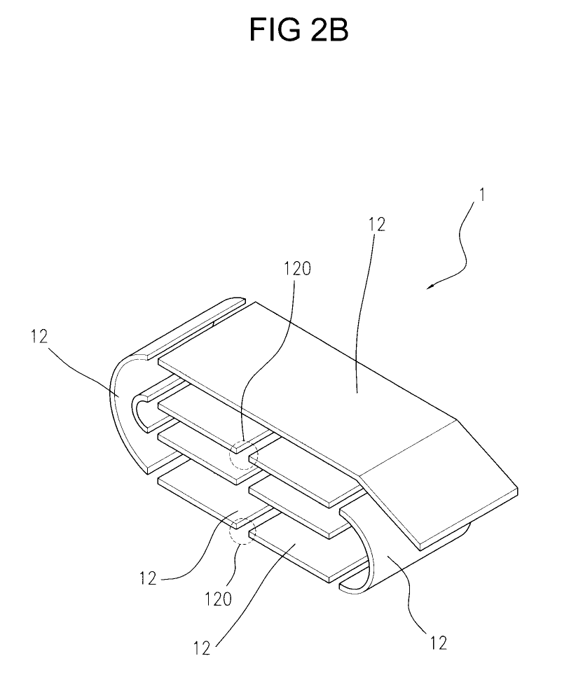

Referring to FIG. 2A, the casing 10 provides a closed structure with a containing space 100 inside. An intake port 102, an outlet port 104 and a plurality of drain ports 106 are disposed at the casing 10 respectively. The casing 10 can be, for instance, a box shaped closed structure. The intake port 102 is connected to an output port of gaseous production provided at the fuel cell directly (not shown). The intake port 102 is disposed at a lateral wall different from position of the outlet port 104.

A fuel cell with direct methyl alcohol is taken as an example in the following for explaining operation of the condenser 1. Steam produced by the fuel cell with direct methyl alcohol enters the condenser 1 via the intake port 102. The drain ports 106 are disposed under the heat dissipating elements 12. When the steam is subjected to action of the heat dissipating elements 12 to condense as liquid, the condensed water flows outward the condenser 1 via the drain ports 106.

Referring to FIG. 2A again, the condenser 1 further includes a gas permeable diaphragm 108 to cover the outlet port 104 tightly.

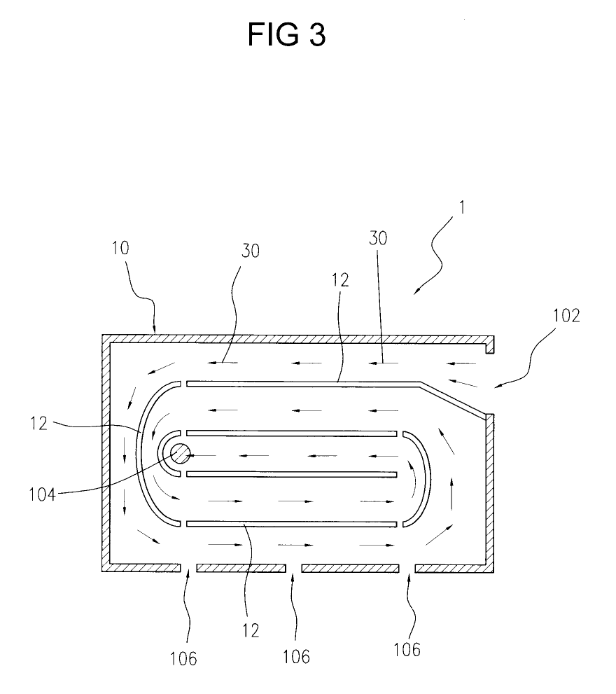

Referring to FIG. 2B, the heat dissipating elements 12 are received in the containing space 100 and are arranged to provide a spiral passage (shown in FIG. 3). The intake port 102 of the condenser 1 is specifically located at the end of the passage. It is noted that the heat dissipating elements 12 are arranged to be perpendicular to two opposite lateral walls of the casing 10 as shown in FIG. 1. Further, it can be seen in FIG. 2B that a clearance is formed between any two adjacent heat dissipating elements 12 and dashed circles 120 indicate two of the clearances. The respective clearance allows the condensed water passing through and flowing downward to bottom wall of the casing 10 so as to moving outward the casing 10. Of course, the condensed water can be recycled for being further used by the fuel cell device. In practice, it is preferable that the clearance is between 0.5 mm and 3 mm.

Referring to FIG. 3, steam molecules shown with arrows in FIG. 3 moving along the spiral passage constituted by the heat dissipating elements 12 are illustrated. The steam molecules entering the casing 10 via the intake port 102 have to pass through the spiral passage before moving outward via the outlet port 104 such that the steam molecules perform heat exchange with big cooling surfaces of the heat dissipating elements 12 during the steam moving along the spiral passage and condense as water drops rapidly. Then, the water drops moving downward via the clearances to congregate at the bottom wall of the casing 10 as condensed water.

In order to promote function of the condenser 1, the casing 10 thereof can be made of heat conductive material such as metal. Cooling fins can be employed as the heat dissipating members 12. Besides, the condenser 1 is suitable for a fuel cell device with either stacked fuel cells or single fuel cell.

It is appreciated that a condenser in a fuel cell device according to the present invention provides a main advantage that the steam produced in the fuel cell device is confined in the containing space 100 for being condensed instead of escaping outward.

Another advantage of the present invention is in that the heat dissipating elements 12 is arranged to constitute a spiral passage for the steam being capable of contacting extremely large cooling area provided by the heat dissipating elements such that time required for condensing the steam is shortened significantly.

While the invention has been described with referencing to a preferred embodiment thereof, it is to be understood that modifications or variations may be easily made without departing from the spirit of this invention, which is defined by the appended claims.

What is claimed is:

1. A condenser in a fuel cell device, comprising:
a casing with an enclosed structure, providing a steam intake port, a steam outlet port and a plurality of drain ports at casing walls and a containing space defined by the casing walls; and
a plurality of heat dissipating elements, being disposed in the containing space above the drain ports and being arranged to constitute a spiral passage;
wherein, the spiral passage has an initial end is disposed at the intake port and a terminal end at the outlet port and the drain ports are positioned under the heat dissipating elements.

2. The condenser in a fuel cell device as defined in claim 1, wherein the heat dissipating elements are perpendicular to two opposite ones of the walls and a clearance is between any two adjacent ones of the heat dissipating elements.

3. The condenser in a fuel cell device as defined in claim 1, wherein the outlet port is covered with a gas permeable diaphragm.

4. The condenser in a fuel cell device as defined in claim 1, wherein the intake port is located at one lateral wall of the casing walls.

5. The condenser in a fuel cell device as defined in claim 1, wherein the outlet port is located at another one lateral wall of the casing walls.

6. The condenser in a fuel cell device as defined in claim 4, wherein the drain ports are arranged at one bottom wall of the casing walls.

7. The condensation device in a fuel battery as defined in claim 1, wherein the heat dissipating elements are cooling fins.

8. The condenser in a fuel cell device as defined in claim 1, wherein the casing is made of heat conductive material.
